(19) United States
(12) Patent Application Publication
(10) Pub. No.: US 2015/0215932 A1
(43) Pub. Date: Jul. 30, 2015

(54) METHOD AND APPARATUS FOR PERFORMING MUTING COORDINATION AND FOR TESTING OF COORDINATING COMMUNICATION

(71) Applicant: NOKIA SOLUTIONS AND NETWORKS OY, Espoo (FI)

(72) Inventors: Xiaoyi WANG, Wheeling, IL (US); De Shan MIAO, Beijing (CN); Bishwarup MONDAL, Beavercreek, OH (US); Eugene VISOTSKY, Buffalo Grove, IL (US)

(73) Assignee: NOKIA SOLUTIONS AND NETWORKS OY, Espoo (FI)

(21) Appl. No.: 14/168,820

(22) Filed: Jan. 30, 2014

(51) Int. Cl. H04W 72/04; H04W 24/08; H04B 7/02

(52) U.S. Cl. CPC H04W 72/0426; H04B 7/024; H04W 24/08; H04W 92/20

(57) ABSTRACT

A method and apparatus can be configured to transmit a physical-resource-block muting request to a neighboring network entity. The method can also include transmitting at least one muting priority level for at least one physical-resource-block of the physical-resource-block muting request.

### BACKGROUND

1. Field

Embodiments of the invention relate to performing muting coordination and to testing of coordinating communication in communication systems such as wireless networks.

2. Description of the Related Art

Long-term Evolution (LTE) is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE has seen extensive deployment in a wide variety of contexts involving the communication of data.

Certain network entities, which use LTE, can perform muting operations by the manner in which they perform physical-resource block (PRB) reservation.

### SUMMARY

According to a first embodiment, a method includes transmitting, by a network entity, a physical-resource-block muting request to a neighboring network entity. The method also includes transmitting at least one muting priority level for at least one physical-resource-block of the physical-resource-block muting request.

In the method of the first embodiment, the network entity and the neighboring network entity include evolved Node Bs.

In the method of the first embodiment, the at least one muting priority level for the at least one physical-resource-block comprises a high priority level, the number of muting priorities that correspond to high priority levels are limited, and the limit is configured by a network or negotiated by evolved Node Bs.

In the method of the first embodiment, the transmitting the physical-resource-block muting request includes transmitting via an X2 interface.

In the method of the first embodiment, the method further includes transmitting an expected user throughput gain to the neighboring network entity. The expected user throughput gain corresponds to an expected user throughput gain that can be achieved if the neighboring network entity performs muting.

According to a second embodiment, an apparatus includes at least one processor. The apparatus also includes at least one memory including computer program code. The at least one memory and the computer program code can be configured, with the at least one processor, to cause the apparatus at least to transmit a physical-resource-block muting request to a neighboring network entity. The apparatus can also be caused to transmit at least one muting priority level for at least one physical-resource-block of the physical-resource-block muting request.

In the apparatus of the second embodiment, the apparatus and the neighboring network entity include evolved Node Bs.

In the apparatus of the second embodiment, the at least one muting priority level for the at least one physical-resource-block includes a high priority level, the number of muting priorities that correspond to high priority levels are limited, and the limit is configured by a network or negotiated by evolved Node Bs.

In the apparatus of the second embodiment, the transmitting the physical-resource-block muting request includes transmitting via an X2 interface.

In the apparatus of the second embodiment, the apparatus can be further caused to transmit an expected user throughput gain to the neighboring network entity. The expected user throughput gain corresponds to an expected user throughput gain that can be achieved if the neighboring network entity performs muting.

According to a third embodiment, a method can include receiving, by a network entity, a physical-resource-block muting request from a neighboring network entity. The method can also include receiving at least one muting priority level for at least one physical-resource-block of the physical-resource-block muting request. The method can also include performing muting depending on the received at least one muting priority level.

In the method of the third embodiment, the network entity and the neighboring network entity include evolved Node Bs.

In the method of the third embodiment, the at least one muting priority level for the at least one physical-resource-block includes a high priority level, the number of muting priorities that correspond to high priority levels are limited, and the limit is configured by a network or negotiated by evolved Node Bs.

In the method of the third embodiment, the method also includes receiving an expected user throughput gain from the neighboring network entity. The expected user throughput gain corresponds to an expected user throughput gain that can be achieved if the network entity performs muting.

According to a fourth embodiment, an apparatus includes at least one processor. The apparatus also includes at least one memory including computer program code. The at least one memory and the computer program code can be configured, with the at least one processor, to cause the apparatus at least to receive a physical-resource-block muting request from a neighboring network entity. The apparatus can also be caused to receive at least one muting priority level for at least one physical-resource-block of the physical-resource-block muting request. The apparatus can also be caused to perform muting depending on the received at least one muting priority level.

In the apparatus of the third embodiment, the apparatus and the neighboring network entity include evolved Node Bs.

In the apparatus of the third embodiment, the at least one muting priority level for the at least one physical-resource-block includes a high priority level. The number of muting priorities that correspond to high priority levels are limited. The limit is configured by a network or negotiated by evolved Node Bs.

In the apparatus of the third embodiment, the apparatus is further caused to receive an expected user throughput gain from the neighboring network entity. The expected user throughput gain corresponds to an expected user throughput gain that can be achieved if the apparatus performs muting.

### BRIEF DESCRIPTION OF THE DRAWINGS

For proper understanding of the invention, reference should be made to the accompanying drawings, wherein:

FIG. 1 illustrates a flowchart of a method in accordance with embodiments of the invention.

FIG. 2 illustrates a flowchart of a method in accordance with embodiments of the invention.

FIG. 3 illustrates an apparatus in accordance with embodiments of the invention.

FIG. 4 illustrates an apparatus in accordance with embodiments of the invention.

FIG. 5 illustrates an apparatus in accordance with embodiments of the invention.

### DETAILED DESCRIPTION

Embodiments of the present invention are directed to a management scheme for coordinating inter-evolved-Node-B (inter-eNB) interference. When using this management scheme, access nodes exchange information in order to determine the behavior of eNBs in an enhanced-coordinated-multi-point (eCoMP) environment, as described in more detail below. Embodiments of the present invention can define an inter-eNB X2 message to exchange the needed information for eNBs to determine a muting pattern, for example. Based on the information received (related to a throughput gain), an eNB may decide whether to mute itself or not, as described in more detail below. When using a coordinated muting scheme, because information sent by a given eNB may be exaggerated for the benefit of the given eNB, in order to ensure that neighboring eNBs are properly muted, it may be necessary to test that the sent information is valid, as described in more detail below.

Embodiments of the present invention are directed to inter-eNB coordinated muting. According to embodiments of the present invention, in order for a neighboring eNB to perform muting, a muting request message is transmitted via an X2 interface to the neighboring eNB. The requests have an accompanying priority so that the neighboring eNBs can use the priority to decide if and when they should perform muting, as described in more detail below.

In LTE Release 12, enhanced coordinated multi-point (CoMP) is directed to performing inter-evolved-Node-B (inter-eNB) coordination under non-ideal backhaul conditions. The coordination is normally performed in view of certain latency and capacity limitations. In general, there exist two network structures for implementing multiple eNB coordination. One network structure includes a distributed architecture, and another network structure includes a centralized architecture.

When using a distributed architecture, each eNB may send (1) channel-state-information (CSI) relating to a user equipment (UE) and/or (2) a benefit metric (relating to a muting request for a neighboring cell) to a neighboring eNB. Upon receipt of the above by each neighboring eNB, each neighboring eNB may make a physical-resource-block (PRB) reservation (muting) decision according to the received CSI information and/or the received muting request. Each eNB may thus send muting request to other neighboring eNBs.

When using a centralized architecture, one central node and/or a central eNB collects each cell's CSI and/or muting requests, and then the central node will make the decision for all coordinated cells as to how muting should occur. The central node then sends the decision to each eNB corresponding to the coordinated cells. When using the centralized network structure, information exchange may suffer from backhaul latency. Another difficulty when using the centralized network structure is that the central node may also restrict eNB implementation flexibility.

Embodiments of the present invention can be directed to a distributed information exchange for realizing inter-eNB coordination for resource allocation. Further, in embodiments of the present invention, a new inter-eNB X2 message can exchange the needed information for a given eNB to determine a muting pattern. The exchanged information/metric can be defined as a throughput gain conditioned upon muting a neighbor cell. This metric can be testable, and embodiments of the present invention are also directed to a test methodology to be captured in RAN4.

In an LTE Release 8 network, inter-eNB coordination is based on slow informative inter-cell-interference-coordination (ICIC) signaling. Such signaling can include an overload indication (OI), a high-interference indication (HII), and a relative-narrowband-transmission-power (RNTP). Such signaling is informative signaling because each eNB can decides for itself whether to make a reservation decision for muting.

An uplink (UL) Interference OI can indicate an interference status on each PRB of uplink. For example, a high/middle/low interference status can be indicated. An UL HII can indicate an interference sensitivity on each PRB of UL. For example, a high/middle/low sensitivity can be indicated.

A downlink (DL) RNTP can indicate the transmitted power status for each PRB of DL. For example, a RNTP can indicate whether the transmitted power status exceeds a threshold. When using the above information, interference status and/or interference prediction is indicated to neighboring eNBs.

In Release 11 CoMP, an ideal backhaul is assumed. Therefore, no special enhancement is needed to address inter-eNB coordination based on a non-ideal backhaul condition. In Release 12 non-ideal backhaul CoMP, gains from using a coordinated muting scheme can be shown. In this scheme, an inter-eNB may need to exchange the channel-state-information (CSI), and then a central node and/or each eNB can autonomously determine whether to perform PRB muting of associated cells. Elegant muting can yield additional benefits due to strong interference removing, although a PRB usage ratio may be decreased.

Upon further analysis of the coordination mechanism, CSI-based information exchange can be seen to have a number of drawbacks. One drawback is that testing the CSI as an X2 message may be difficult because the CSI is reported from a UE. Another drawback is that exchanging information for each UE has a common problem. Specifically, such exchanging of information may not be suitable for Voice-over-Internet-Protocol (VoIP) and Web Browsing types of small traffic packages. When such information is exchanged, the UE has probably already left the relevant area. Another drawback is that information such as CSI is very sensitive to latency. Latency may degrade performance gain.

Another type of information is a benefit metric corresponding to the muting of a neighboring cell. A neighboring cell will make the decision to perform or to not perform muting based upon its own penalty due to muting and based on how other cells benefit from muting by this neighboring cell. However, using this metric has similar issues when as using CSI, and the metric is linked to a specific algorithm. In embodiments of the invention, one new information exchange signaling can be used to assist eNBs in the making of muting decisions.

Embodiments of the present invention are directed to a coordination mechanism for implementing inter-cell muting. Embodiments of the present invention can comprise X2 message enhancement, and can provide a signaling design for signaling a muting request. An eNB can send a PRB muting request to another eNB via an X2 interface, and the PRB muting request can be accompanied by a muting priority level for each PRB. A PRB muting request can be accompanied by different muting priority levels for a plurality of PRBs. In one embodiment, priority can be designated as corresponding to different states, for example, high or low states.

Upon receiving a muting request message, a neighboring eNB can make a muting decision according to the request priority. The receiving neighboring eNB can try to fulfill the received muting requests on PRBs that are designated as having high priority. The neighboring eNB can then try to meet the muting request on PRBs with lower priority (without sacrificing its own cell performance). Performing muting by an eNB on a PRB generally means that the eNB should avoid transmitting data (avoid transmitting data on a Physical Downlink Shared Channel and/or an Enhanced Physical Downlink Control Channel) in the PRB. Unmuting generally means that the eNB can transmit data on that particular PRB if the eNB wants to. In order to avoid misuse of eNB muting requests, the number of high priority PRBs that can be indicated in a muting request by a requesting eNB can be limited. The maximum number can be configured by a network, or can be negotiated by eNBs. Embodiments of the present invention can define a new X2 message to negotiate a maximum number of high-priority PRBs in a muting request.

In one example of implementing an embodiment of the invention, an eNB can determine this limit number of high priority PRBs based on the eNB's historical PRB utilization information. If the eNB has many PRBs that are empty, the eNB can inform neighboring eNBs to send muting requests with more high-priority PRBs. Additionally, muting request information can be tagged with a duration in order to avoid excessive resource cost.

Embodiments of the present invention can provide low overhead for X2 signaling. Embodiments of the present invention can also provide a muting priority that can help eNBs make muting decisions. Embodiments of the present invention can be easy to implement and test. As described above, an eNB can try to mute the PRBs with high priority. Embodiments of the present invention may avoid restricting eNB behaviors. As such, each eNB may be able to perform its coordinating decision autonomously

In eCoMP and with any other inter-eNB coordinated interference management scheme (such as eICIC, for example), eNBs may exchange some information to determine the behavior of an eNB. Determining which information to be exchanged can be important in defining such a scheme. Such messages can be designed as a metric to quantify the benefit obtained if a neighboring eNB performs a certain behavior. For example, the metric can be the performance gain that results if the neighbor eNB is muted.

There has been discussion relating to what should be exchanged between eNBs to support eCoMP in RAN1#74bis. There also has been discussion related to what happened when eICIC was standardized in Release 10. There were various proposed metrics (to be exchanged between eNBs), for example, the proportional-fair (PF) offset. However, the previous approaches have difficulties relating to testability. In a coordinated muting scheme, every eNB may want its neighbors to be muted. In another words, each eNB has a strong motivation to exaggerate the metric (whichever metric is being) to encourage a neighboring enB to be muted, because the more PRBs that a neighboring eNB mutes, the better throughput the given eNB will enjoy. The previously proposed messaging schemes were generally not testable.

In embodiments of the present invention, a throughput gain can be defined as the expected user throughput gain that may be achievable, given that a particular cell of a neighboring eNB (the receiving eNB) is muted. In other words, the expected user throughput gain can be used to quantify an expected gain that the UE can obtain if some neighbor cell is muted. An eNB can estimate the user throughput based on a reported Channel-Quality-Indicator (CQI) or based on some other method. The basis for the estimation can be the eNB's choice. The throughput gain can be averaged across all of the UEs or over a group of UEs. For example, the group of UEs can be cell-range expansion (CRE) UEs, UEs corresponding to five-percentile UEs, or UEs scheduled in muted PRBs. When the eNB sends the expected user throughput gain to another eNB, the receiving eNB will consider the expected user throughput gain that the sending eNB may achieve if the receiving eNB is muted.

In embodiments of the present invention, suppose that the procedure includes an eNB-1 that gathers CQI from a UE. The eNB-1 then calculates the throughput gain, assuming that another eNB, eNB-2, is muted. In the procedure, the eNB-1 sends the throughput gain information to eNB-2 (a new X2 message may be used for such a transmission). Upon receiving the message, eNB-2 can evaluate whether it should be muted, depending on whether the benefit for eNB-1 is large enough. eNB-2 may also receive a throughput gain message from other eNBs at the same time to make a joint decision. After the decision is made by eNB-2, eNB-2 can send its decision to neighboring eNBs.

In embodiments of the present invention, one advantage of indicating throughput gain is that the indications may be testable. The test environment can include one target eNB, at least one interfering eNB, and one test UE. The test UE can be used to measure the throughput. The test UE can be connected to the target eNB. Embodiments of the present invention can first measure the throughput of the UE (connected to the target eNB) in an interference environment. At least one interference eNB is transmitting on a Physical-Downlink-Shared-Channel (PDSCH) at the same time. Embodiments of the present invention can let the target eNB send the throughput gain information to the interfering eNB. Embodiments of the present invention can then mute the interfering eNB and measure the throughput of the target eNB again. The throughput gain can be determined based upon the activity of the receiving/interfering eNB. So, the UE can achieve a corresponding gain in throughput when the interfering eNB applies muting.

Embodiments of the present invention can be directed to how to estimate the throughput gain depending on an eNB implementation. For example, a Release 11 UE can report two CQIs, CQI-1 can be the normal CQI, and CQI-2 can be the muted CQI. A network can then calculate the throughput using the muted CQI and compare the throughput based on the normal CQI.

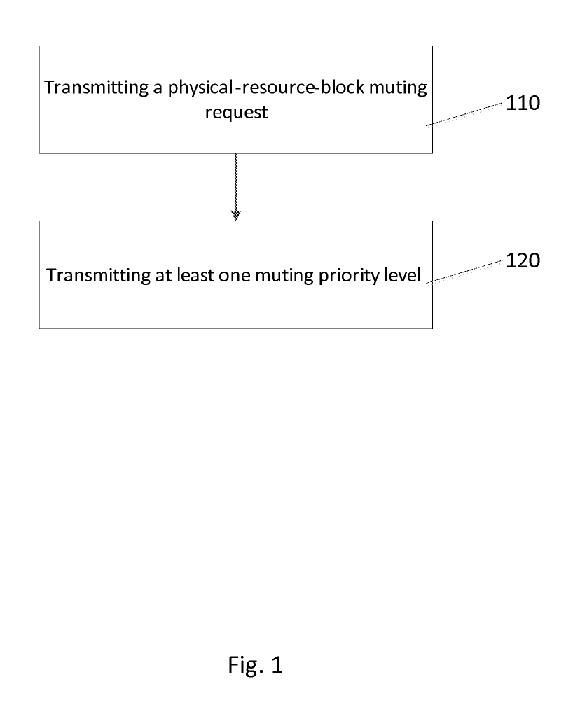

FIG. 1 illustrates a flowchart of a method in accordance with embodiments of the invention. The method illustrated in FIG. 1 includes, at 110, transmitting, by a network entity, a physical-resource-block muting request to a neighboring network entity. The method includes, at 120, transmitting at least one muting priority level for at least one physical-resource-block of the physical-resource-block muting request.

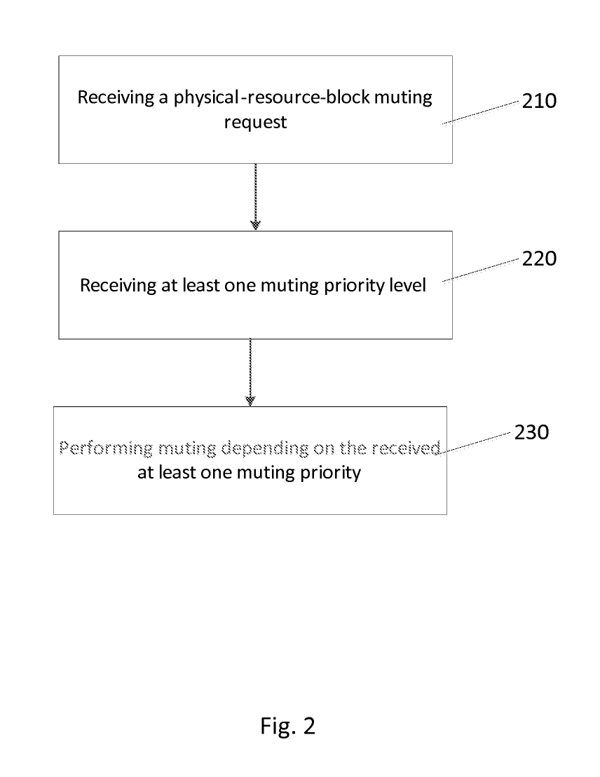

FIG. 2 illustrates a flowchart of a method in accordance with embodiments of the invention. The method illustrated in FIG. 2 includes, at 210, receiving, by a network entity, a physical-resource-block muting request from a neighboring network entity. The method also includes, at 220, receiving at least one muting priority level for at least one physical-resource-block of the physical-resource-block muting request. The method also includes, at 230, performing muting depending on the received at least one muting priority level.

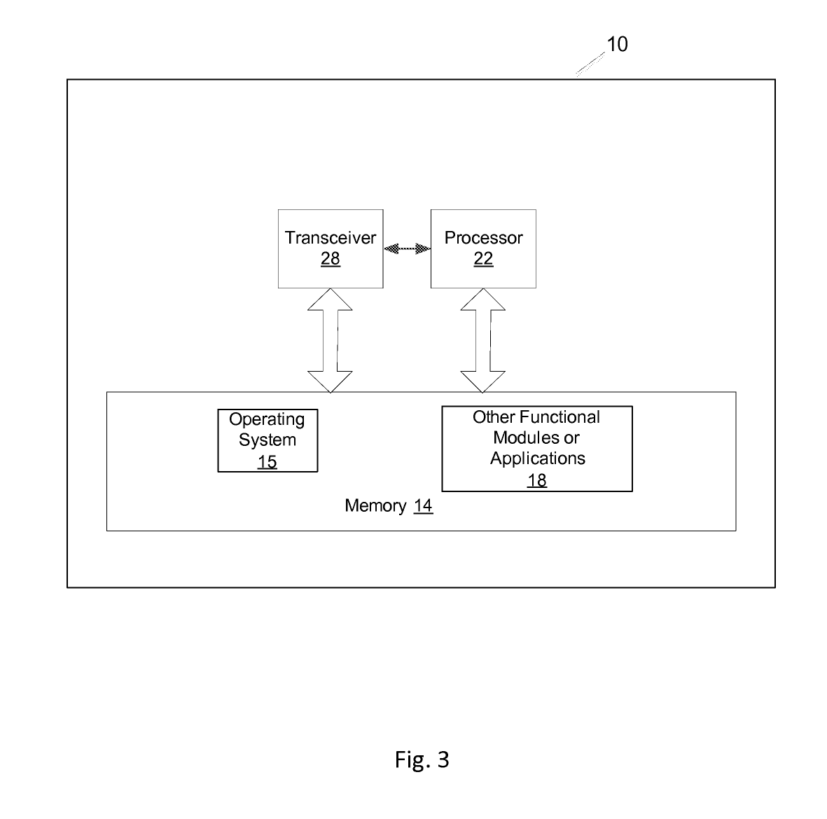

FIG. 3 illustrates an apparatus in accordance with embodiments of the invention. In one embodiment, the apparatus can be a network entity such as an evolved Node B/base station. Apparatus 10 can include a processor 22 for processing information and executing instructions or operations. Processor 22 can be any type of general or specific purpose processor. While a single processor 22 is shown in FIG. 3, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. Memory 14 can include any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 can store software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

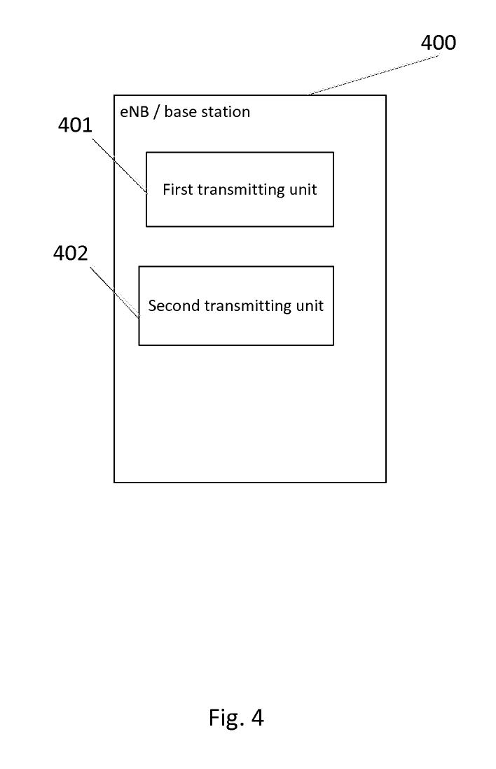

FIG. 4 illustrates an apparatus in accordance with embodiments of the invention. Apparatus 400 can be a network entity such as an eNB/base station, for example. Apparatus 400 can include a first transmitting unit 401 that transmits a physical-resource-block muting request to a neighboring network entity. Apparatus 400 can also include a second transmitting unit 402 that transmits at least one muting priority level for at least one physical-resource-block of the physical-resource-block muting request.

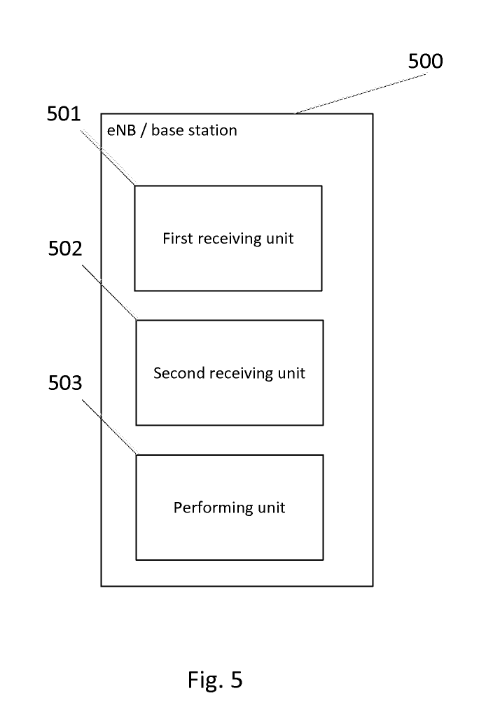

FIG. 5 illustrates an apparatus in accordance with embodiments of the invention. Apparatus 500 can be a network entity such as an eNB/base station, for example. Apparatus 500 can include a first receiving unit 501 that receives a physical-resource-block muting request from a neighboring network entity. Apparatus 500 can also include a second receiving unit 502 that receives at least one muting priority level for at least one physical-resource-block of the physical-resource-block muting request. Apparatus 500 can also include a performing unit 503 that performs muting depending on the received at least one muting priority level.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. A method, comprising:
transmitting, by a network entity, a physical-resource-block muting request to a neighboring network entity; and
transmitting at least one muting priority level for at least one physical-resource-block of the physical-resource-block muting request.

2. The method according to claim 1, wherein the network entity and the neighboring network entity comprise evolved Node Bs.

3. The method according to claim 1, wherein the at least one muting priority level for the at least one physical-resource-block comprises a high priority level, the number of muting priorities that correspond to high priority levels are limited, and the limit is configured by a network or negotiated by evolved Node Bs.

4. The method according to claim 1, wherein the transmitting the physical-resource-block muting request comprises transmitting via an X2 interface.

5. The method according to claim 1, further comprising transmitting an expected user throughput gain to the neighboring network entity, wherein the expected user throughput gain corresponds to an expected user throughput gain that can be achieved if the neighboring network entity performs muting.

6. An apparatus, comprising:
at least one processor; and
at least one memory including computer program code,
the at least one memory and the computer program code configured, with the at least one processor, to cause the apparatus at least to
transmit a physical-resource-block muting request to a neighboring network entity; and
transmit at least one muting priority level for at least one physical-resource-block of the physical-resource-block muting request.

7. The apparatus according to claim 6, wherein the apparatus and the neighboring network entity comprise evolved Node Bs.

8. The apparatus according to claim 6, wherein the at least one muting priority level for the at least one physical-resource-block comprises a high priority level, the number of muting priorities that correspond to high priority levels are limited, and the limit is configured by a network or negotiated by evolved Node Bs.

9. The apparatus according to claim 6, wherein the transmitting the physical-resource-block muting request comprises transmitting via an X2 interface.

10. The apparatus according to claim 6, wherein the apparatus is further caused to transmit an expected user throughput gain to the neighboring network entity, wherein the expected user throughput gain corresponds to an expected user throughput gain that can be achieved if the neighboring network entity performs muting.

11. A method, comprising:
receiving, by a network entity, a physical-resource-block muting request from a neighboring network entity;
receiving at least one muting priority level for at least one physical-resource-block of the physical-resource-block muting request; and
performing muting depending on the received at least one muting priority level.

12. The method according to claim 11, wherein the network entity and the neighboring network entity comprise evolved Node Bs.

13. The method according to claim 11, wherein the at least one muting priority level for the at least one physical-resource-block comprises a high priority level, the number of muting priorities that correspond to high priority levels are limited, and the limit is configured by a network or negotiated by evolved Node Bs.

14. The method according to claim 11, further comprising receiving an expected user throughput gain from the neighboring network entity, wherein the expected user throughput gain corresponds to an expected user throughput gain that can be achieved if the network entity performs muting.

15. An apparatus, comprising:
at least one processor; and
at least one memory including computer program code,
the at least one memory and the computer program code configured, with the at least one processor, to cause the apparatus at least to
receive a physical-resource-block muting request from a neighboring network entity;
receive at least one muting priority level for at least one physical-resource-block of the physical-resource-block muting request; and
perform muting depending on the received at least one muting priority level.

16. The apparatus according to claim 15, wherein the apparatus and the neighboring network entity comprise evolved Node Bs.

17. The apparatus according to claim 15, wherein the at least one muting priority level for the at least one physical-resource-block comprises a high priority level, the number of muting priorities that correspond to high priority levels are limited, and the limit is configured by a network or negotiated by evolved Node Bs.

18. The apparatus according to claim 15, wherein the apparatus is further caused to receive an expected user throughput gain from the neighboring network entity, wherein the expected user throughput gain corresponds to an expected user throughput gain that can be achieved if the apparatus performs muting.
